(19) United States
(12) Patent Application Publication
(10) Pub. No.: US 2013/0227432 A1
(43) Pub. Date: Aug. 29, 2013

(54) METHOD FOR USING AN ELECTRONIC CALENDAR AND A HANDHELD MOBILE ELECTRONIC DEVICE USING THE SAME

(71) Applicant: HTC Corporation, (US)

(72) Inventor: Yi-Shan Lin, Taoyuan County (TW)

(73) Assignee: HTC Corporation, Taoyuan County (TW)

(21) Appl. No.: 13/748,606

(22) Filed: Jan. 24, 2013

Related U.S. Application Data
(60) Provisional application No. 61/602,609, filed on Feb. 24, 2012.

(51) Int. Cl. H04L 12/24

(52) U.S. Cl. CPC H04L 41/22
USPC 715/753

(57) ABSTRACT

The present disclosure provides a calendar application or widget for use on a handheld electronic mobile device. This calendar application is able to post birthday greets on a web page of a social network without having to launch the application of the social network. The calendar application is able to synchronize with external data storages from the cloud storage. Upon synchronizing the data, a user is able to obtain information regarding events and be reminded by the event. When a reminder is triggered, a user is able to respond by sending greetings to personal contacts or to invite contacts to the event, and the response can be synchronized with external servers.

### CROSS REFERENCE TO RELATED APPLICATION

This application claims the priority benefit of U.S.A. provisional application Ser. No. 61/602,609, filed on Feb. 24, 2012. The entirety of the above-mentioned patent application is hereby incorporated by reference herein and made a part of specification.

### BACKGROUND

1. Technical Field

The present disclosure generally relates to a method of using an electronic calendar and a handheld mobile electronic device using the same.

2. Related Art

An handheld mobile electronic device such as a mobile phone or PDA is often equipped with an electronic calendar application or widget which may very well be an indispensable tool in the modern life. Generally, a user may plan events on certain dates of a month or a year using the calendar as well as activities within a single date. In other words, a user may customize one's own calendar by entering information to annotate a certain date or a certain time of the day. As the result of the recent development of an electronic calendar in a mobile phone, the electronic calendar has replaced the function of a traditional calendar and a traditional planner as a business person no longer has to carry one's planner around in a suitcase.

Also recent technological advancements have brought about social networks which not only bring people closer together but also enable people to stay connected to other people's lives. Consequently, a person not only has one's own calendar but may also be expected to keep track of other people's calendars when they are shared willingly by others. Currently, various social networks have implemented functions such as events planning in certain time of a day or a calendar function which records a person's birthday or various special events.

A conventional calendar application for mobile phone may synchronize with various social networks to obtain personal information such as people's profiles, photographs, or data uploaded to the social networks. However, calendar functions between various platforms such as web based social networks, messengers, or mobile phones are not yet fully synchronized. For instance, when a birthday reminder is triggered by a calendar application in accordance with the profile data obtained from the social networks, a user still has to additionally launch the social network application if he/she wants to post a birthday greeting on that friend's web page provided by the social network.

### SUMMARY OF THE DISCLOSURE

This present disclosure provides a method of a calendar application/widget interaction among users and with online services while showing a reminder triggered by the information obtained from the online services.

The present disclosure directs to a handheld mobile electronic device which implements functions of a calendar application/widget interaction among users and with online services while showing a reminder triggered by the information obtained from the online services

According to an exemplary embodiment, the method of the present disclosure performs the steps of first synchronizing the electronic calendar with an external data storage to generate a synchronized data, generating automatically an event according to the first synchronized data, displaying the event, inputting a user response based on the event, transmitting the user response to selected users, and synchronizing the user response with the external data storage.

According to an exemplary embodiment, the method of the present disclosure displays the first response on a social networking website without launching the social networking website.

According to an exemplary embodiment, the method of the present disclosure creates an invitational list for the first event and synchronizes the invitational list with the external data storage.

According to an exemplary embodiment, the method of the present disclosure transmits the user response to members on the invitation list.

According to an exemplary embodiment, the method of the present disclosure the user response is a text message, an email, a video, or a file attachment and is transmitted to each member of the invitation list.

According to an exemplary embodiment, the method of the present disclosure creates automatically an event on a social networking website with invited guests from the invitation list without launching the social networking website.

According to an exemplary embodiment, the method of the present disclosure sets a reminder message to be triggered before a predetermined time period of the first event; and triggers the reminder message before the predetermined time period of the first event.

According to an exemplary embodiment, the method of the present disclosure allows dragging and dropping of the electronic calendar on a home screen of the handheld mobile device and displays the electronic calendar as a widget on the home screen.

According to an exemplary embodiment, the method of the present disclosure sends a birthday greeting to a social networking website without launching the website.

According to an exemplary embodiment, the method of the present disclosure synchronizes data with the external data storage from a web based social networking website, from a messenger service, from an email server, or from a calendar server.

According to an exemplary embodiment, the mobile handheld electronic of the present disclosure at least contains a communication unit, a storage unit, an input unit, a display unit, and a processing unit connected to the communication unit, the storage unit, the input unit, the display unit.

According to an exemplary embodiment, the mobile handheld electronic of the present disclosure configures the communication unit for synchronizing the electronic calendar with an external data storage to generate a first synchronized data, the storage unit for storing the first synchronized data, the input unit for inputting a first response based on the first synchronized data, the processor for transmitting the first response through the communication unit and for synchronizing the first response with the external data storage through the communication unit.

According to an exemplary embodiment, the mobile handheld electronic of the present disclosure configures the communication unit for transmitting the first response to be displayed on a social networking website without launching the social networking website.

According to an exemplary embodiment, the mobile handheld electronic of the present disclosure configures the processor for synchronizing through the communication unit an invitational list created for the first event with the external data storage.

According to an exemplary embodiment, the mobile handheld electronic of the present disclosure configures the communication unit for transmitting the first response to members on the invitation list.

According to an exemplary embodiment, the mobile handheld electronic of the present disclosure configures transmits the first response which could be a phone call, a text message, an email, a video, or a file attachment.

According to an exemplary embodiment, the mobile handheld electronic of the present disclosure configures the communication unit for transmitting the first event and the invitational list to be generated as a social event with a invited guest list on a social networking website without launching the social networking website.

According to an exemplary embodiment, the mobile handheld electronic of the present disclosure configures the processor for setting a reminder message to be triggered before a predetermined time period of the first event, and triggering the reminder message before the predetermined time period of the first event.

According to an exemplary embodiment, the mobile handheld electronic of the present disclosure configures a display unit for displaying the electronic calendar as a widget on the home screen when the electronic calendar is dragged and dropped on the home screen of the handheld electronic mobile device.

According to an exemplary embodiment, the mobile handheld electronic of the present disclosure configures the processor to send through the communication unit a birthday greeting to be displayed on a social networking website without launching the website.

According to an exemplary embodiment, the mobile handheld electronic of the present disclosure configures the communication unit to synchronize data from a web based social networking website, from a messenger service, from an email server, or from a calendar server.

The accompanying drawings are included to provide a further understanding of the disclosure and are incorporated in and constitute a part of this specification. The drawings illustrate embodiments of the disclosure and, together with the description, serve to explain the principles of the disclosure.

### BRIEF DESCRIPTION OF THE DRAWINGS

FIG. 1 illustrates the agenda view of the calendar application or widget.

FIG. 2 illustrates the agenda view of the calendar application or widget dropped onto a home screen.

FIG. 3 illustrates an event details view of the calendar application or widget.

FIG. 4 illustrates an editing interface for sending a birthday greeting.

FIG. 5 illustrates a menu for sending a greeting message.

FIG. 6 illustrates the flow chart of sending a birthday greeting to a friend on a social networking website.

FIG. 7A illustrates the agenda view of a list of events integrating an online calendar function.

FIG. 7B illustrates the holiday details view of an event integrated into an online calendar function.

FIG. 7C illustrates a dialog interface for editing an event and for inviting friends by from Google calendar.

FIG. 7D illustrates a dialog interface for editing an event and for inviting friends by from an email program.

FIG. 8 is a flow chart illustrating an example of integrating Google calendar or Exchange into the calendar application/widget and create an invitation of an event corresponding to the calendar data from Google calendar.

FIG. 9 illustrates a mobile device electronic device for executing a calendar function according to an exemplary embodiment of the present disclosure.

### DETAILED DESCRIPTION OF DISCLOSED EMBODIMENTS

Reference will now be made in detail to the present embodiments of the invention, examples of which are illustrated in the accompanying drawings. Wherever possible, the same reference numbers are used in the drawings and the description to refer to the same or like parts.

The present disclosure provides a method of a calendar application/widget interaction among users and with online services while showing a reminder triggered by the information obtained from the online services.

According to an exemplary embodiment of the present disclosure, when the calendar application for mobile phone synchronizes with various social networks such as MySpace or Facebook, personal information such as people's profiles, photographs, daily agenda, or events entered into the social networks may be obtained. When the calendar application receives a birthday reminder triggered by the calendar application in accordance with the profile data obtained from the social networks, the user may post a birthday greeting on a webpage of the social networks without having to additionally launch the social network applications.

Each time when a user logs into a social network, all time and dates related information from the social network, for instance, birthday dates, anniversaries, or any special dates of friends in the social network, or data of calendar events of the social network will be downloaded from the cloud storage into a storage of the mobile phone. The time, date, and information of each event which might be useful for the calendar application is downloaded and is then integrated into the database of the calendar application/widget so that a brief description about each time, date, and information related to each calendar event from the online service may be displayed on an agenda view of the calendar application or widget. However, the user may also view the time, date, and related information of each event obtained from the online service in the month view or day view.

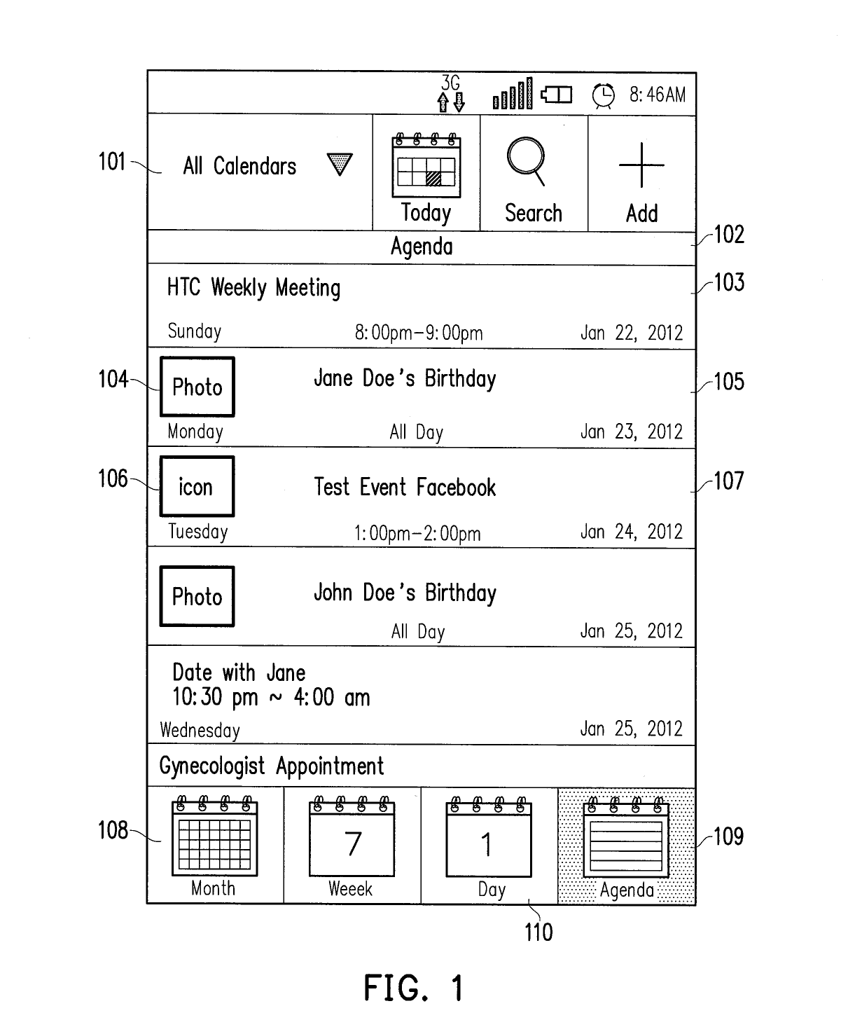

FIG. 1 illustrates the agenda view of a calendar application or widget in accordance with an exemplary embodiment of the present disclosure. From the agenda view, the date, time, and related information of various events may be shown. These events may be events entered manually by a user or events synchronized from another source. A user may touch on the menu named All Calendars 101 to select what targets the calendar application or widget of this mobile phone may want to synchronize with. For instance, the mobile phone may synchronize with calendar applications of a PC, an email server such as Gmail, a web based social networks such as Facebook or MySpace, or a messenger service.

Under the agenda list 102, it may shown a list of events. For each event, it may include a photograph 104 or a representative icon 106 for the event. Also an event may have the name of the event, the time and date of the event, and a description for the event. For instance, the agenda list 102 may show a weekly recurring event such as a weekly meeting 103. It may show a birthday event 105 including a person's photograph 104 downloaded from a social network or entered manually. It may include a downloaded event from a social network 107 represented by an icon 106. A user may touch on any one of these listed event to obtain a more detailed view of each event.

Besides the agenda view, a user may also switch among other views (not shown) by touching on menus on the bottom of the menu including the monthly view 108, weekly view, daily view 110, and the agenda view 109. The month view may show various events, including synchronized events, annotated on a calendar of the mobile phone. The daily view works like a daily planner and may list all the events of the times of a day. The agenda view 109 as previous mentioned, is a compiled list of all the events manually entered or downloaded and ascending sorted according to time.

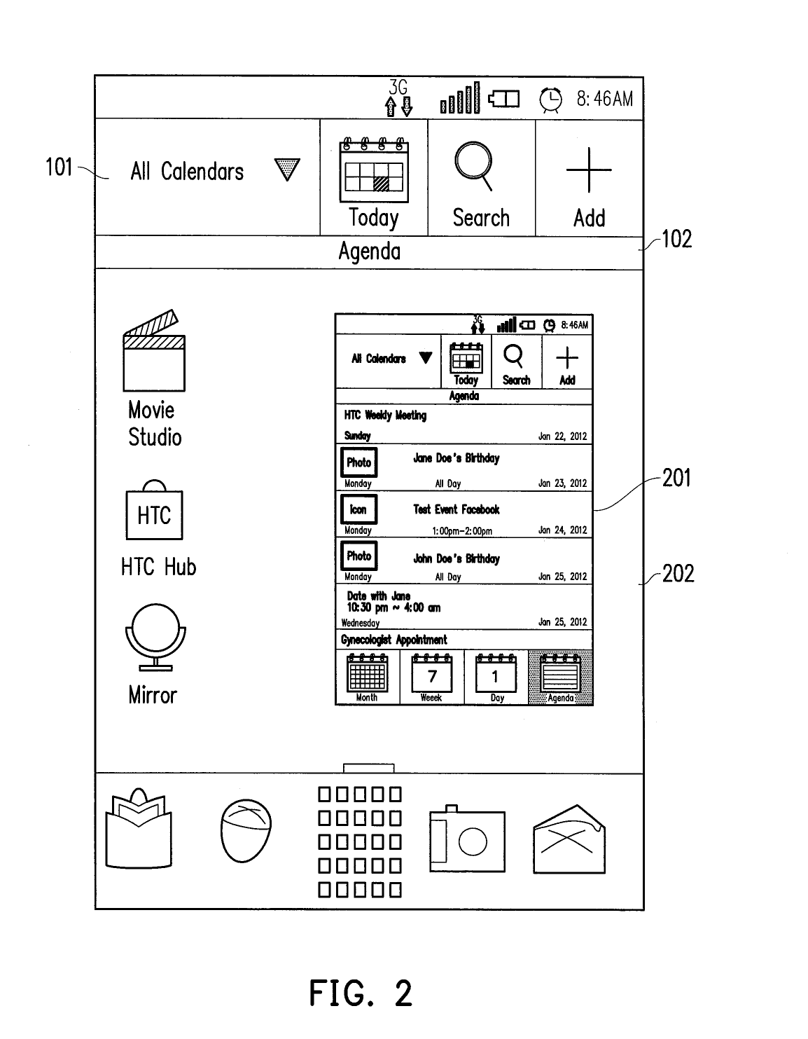

FIG. 2 illustrates the agenda view of the calendar widget 201 dropped onto the home screen 202. The agenda view of the calendar application according to FIG. 1 may be selected and dropped onto a home screen of the mobile device and become a calendar widget 201 on the home screen 202. With the calendar widget 201 on the home screen 202, a user may quickly recognize an upcoming birthday or a schedule event with the date and time and all the related information of the event through the agenda view of the calendar widget as shown in FIG. 2.

For each event of the calendar application or widget, the reminder time of each event may be set by a user. The user may decide what predetermined time period before the time of the event would trigger the reminder. To set the reminder time, a user may tap an item on the agenda list 102 to see the details thereof Alternatively, when the reminder of the item is displayed to the user, the details thereof is showing on the reminder.

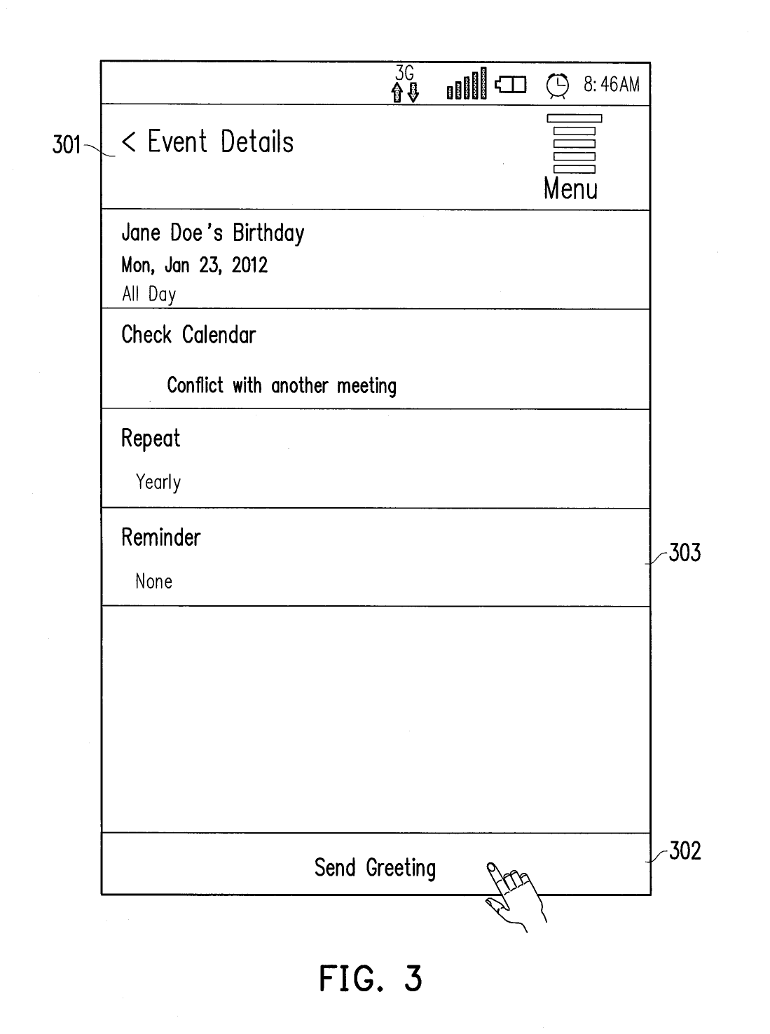

The reminder time may be set by a user from the event details view. FIG. 3 illustrates the event details view 301 according to an exemplary embodiment of the present disclosure. If a user touches the item Jane Doe's Birthday 105 from the agenda view in FIG. 1, it brings the users to the event detail view 301 of the birthday event 105. The event detail view 301 contains a list of menus. An user may touch the reminder menu 303 to set the reminder for this particular event. For example, a person may set the reminder to one week, one day, or one hour, and the reminder in this case may trigger every year to remind a user this particular event since the reminder in FIG. 3 is set to repeat yearly.

A person may also send a birthday greeting from the event details view 301 by touching Send Greeting 302 software button on the event details view. When the Send Greeting 302 button is touched, a dialog menu may be launched.

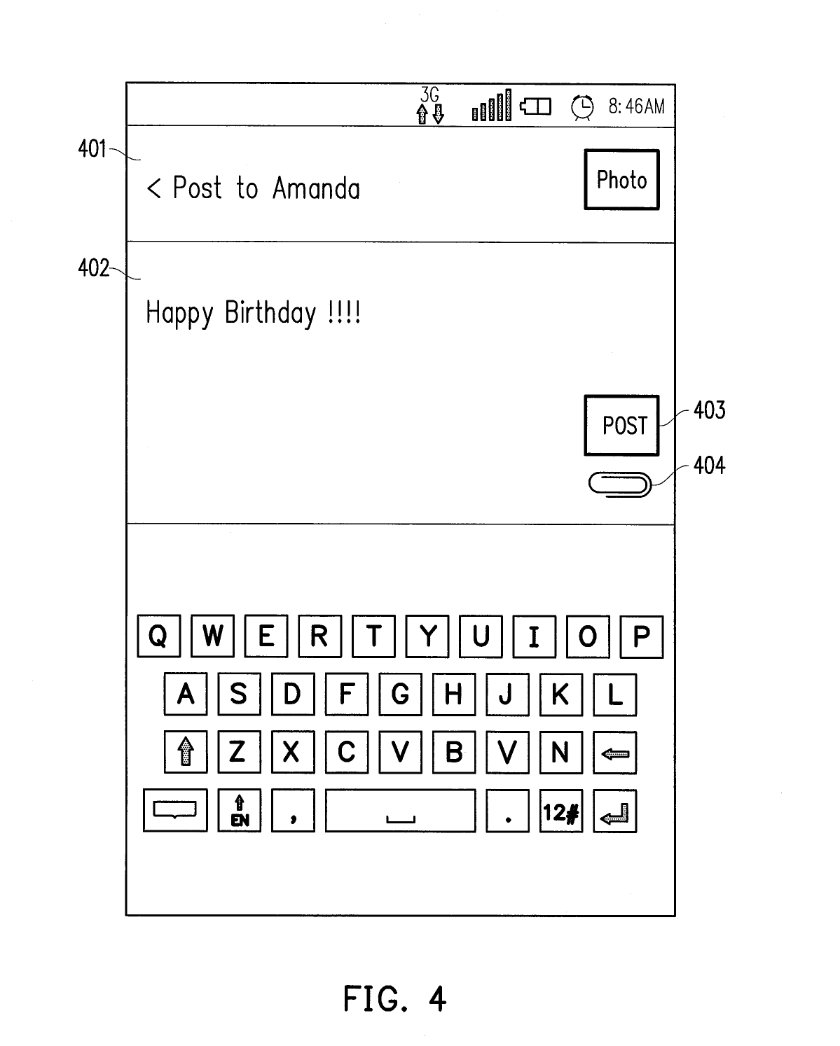

FIG. 4 illustrates the dialog menu according to an exemplary embodiment of the present disclosure. The dialog menu has a software keyboard on a part of the screen to enter a message for a recipient or to edit a default message. As shown in FIG. 3, a contact's name 401 is identified on the dialog menu with a profile photograph obtained from an online service to be displayed as an identification. There is a text area 402 for a user to enter or edit the greetings message. A user may attach a file by using the clip button 404. Alternatively, a default message/image/icon/video/hyper link may be displayed in the dialogue for a user to edit or to send the content directly.

When a user is finished with the editing and the file attachment, POST 403 may be tapped to send the greeting message onto the friend's webpage provided by the online service. For example, if the birthday information is acquired from Facebook, the greeting content will be directly posted on the friend's Wall after the user tap on the “POST” button.

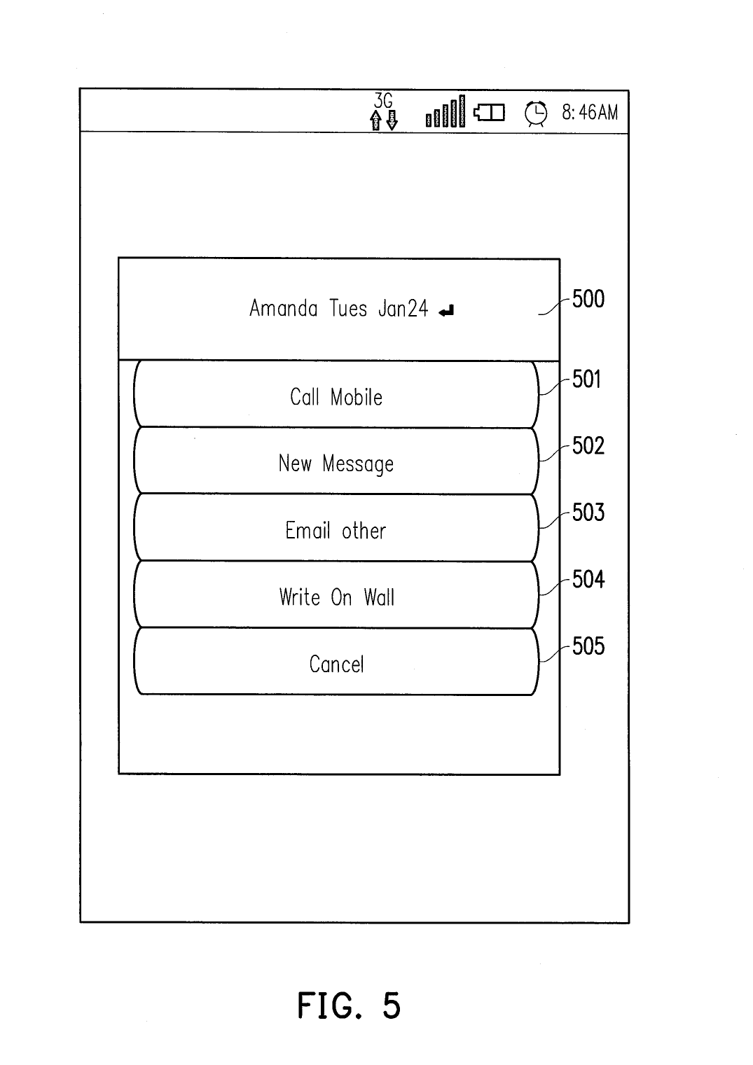

In another exemplary embodiment, after a user taps on the Send Greeting 302 software button as shown in FIG. 3, there may be a pop up menu for displaying various options of sending a greeting. FIG. 5 illustrates a pop up menu 500 for sending a greeting in accordance with the exemplary embodiment. The pop up menu 500 shows a person's name and date on the top of the menu. If a user taps on the “Call mobile” option 501, the “New message” option 502, or the “Email other” option 503, the related application such as the Phone call application, the SMS application and the Email application will be launched for the user to make a phone call, to create a SMS message, or to write an e-mail. Similarly, a dialog for editing a greetings message as shown in FIG. 4 may be displayed if the user taps on the “Write on wall” option 504. Then after the user selects the “POST” button, the greeting content will be directly posted on the friend's Wall without launching the Facebook application. However, if the user does not want to send any greeting, he/she may tap on the “Cancel” option 505 to return to the Agenda view of the calendar application or widget.

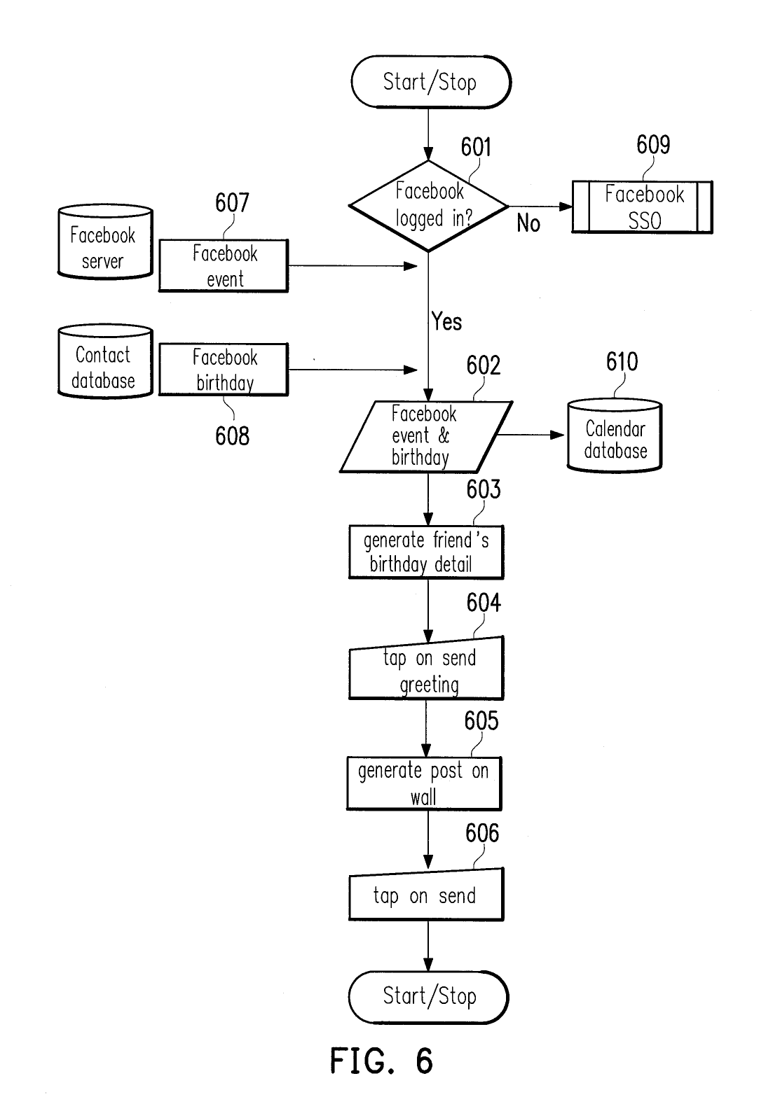

FIG. 6 illustrates a flow chart for sending a birthday greeting to a friend on Facebook while the birthday information and the event information are acquired from Facebook and integrated into the calendar application or m,widget. In step 601, the mobile phone determines whether a user is logged into Facebook. If a user is not logged into Facebook, in step 609 the user may first need to log into Facebook. If a user is logged into Facebook, in step 607, Facebook events from Facebook server are synchronized with the mobile phone so that Facebook events are integrated into the calendar application or widget of the mobile phone. Also in step 608, the contact database is also synchronized with the mobile phone so that birthdays of contacts from Facebook may be downloaded from the Contact database of Facebook. In step 602, after Facebook events and birthdays are synchronized from the server and database of Facebook, these information are stored in the calendar database of the mobile phone in step 610.

In step 603, after knowing that a friend's birthday has arrived from Facebook or is imminent from the reminder function of the mobile phone as the friend's birthday detail has been generated by the calendar function in step 603, a user may send a birthday greeting message using the dialog menu as shown in FIG. 4. When the greeting message has been sent, in step 605 it gets posted directly on Facebook without having to launch the Facebook application. Alternatively in step 604, a person may also send the greetings through the pop up menu as illustrated in FIG. 5. In step 606, a person may also tap on the clip icon 404 of FIG. 4 to send additional text messages, emails, photographs, videos, or files.

The calendar application or widget integrates information from the online services and provides the instant interaction with the online service for the user while displaying a reminder related to the information from the online services. The interaction may be posting the user edited content on the webpage of the contact's event on the online services. It should be noted that the information obtained form the online service is not limited by the birthday of friends or the event date, and the online service comprises any social networking service.

The followings is an example of integrating an online calendar into the Calendar application/widget in accordance with an exemplary embodiment of the present disclosure, and providing a user interaction based on the online calendar information. To be specific, the online calendar service provides several kinds of online calendar covering distinct holidays based on different cultures for a user to select. After the user login the user account, he/she may select one of the online calendar and add their personal schedule and the memorial day into the online calendar to create a personal online calendar. Each time when a user logs into the account of an online calendar service on the mobile phone, the online calendar data will be downloaded from the cloud storage into the mobile phone, and integrated into the database of the Calendar application/widget. That is, the brief description of each downloaded online calendar data (e.g., friends' birthday, the holiday or the event date) may be displayed on the Agenda view (or the month view or the day view) of the Calendar application & Widget.

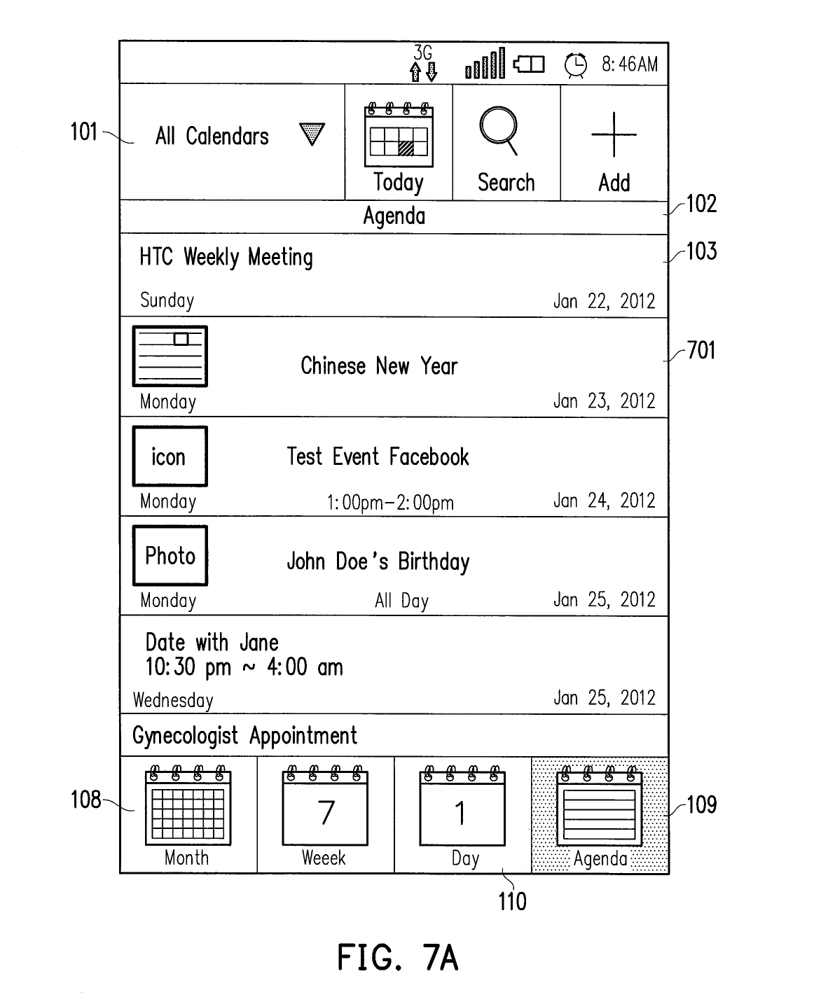

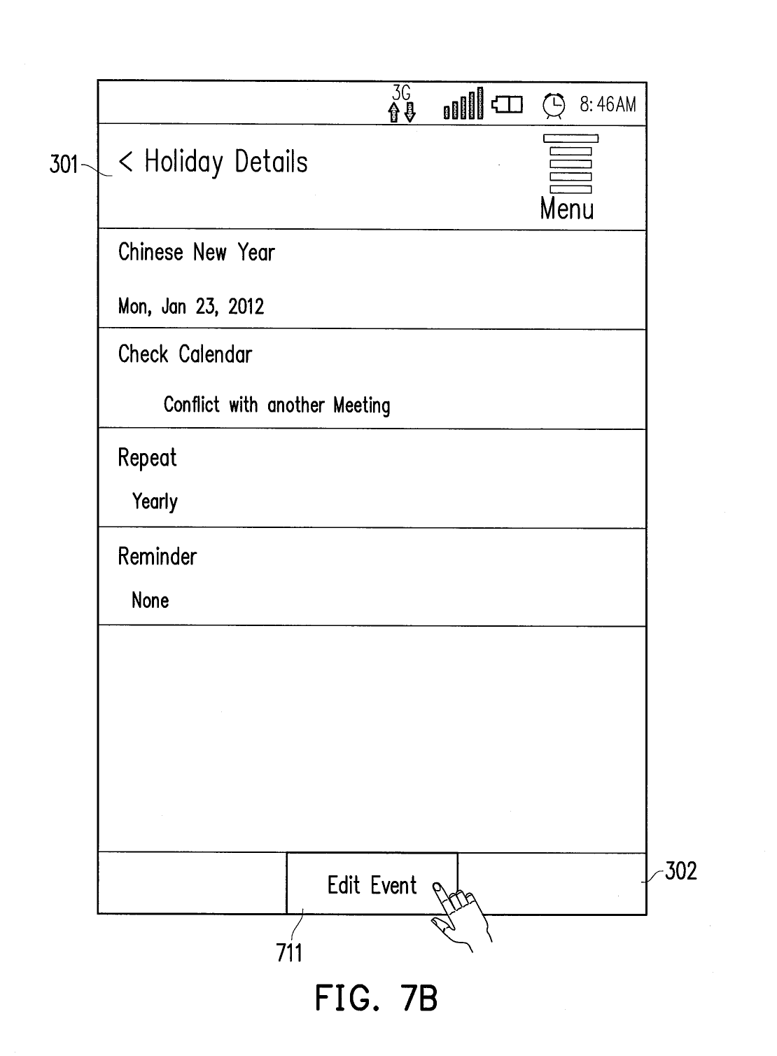

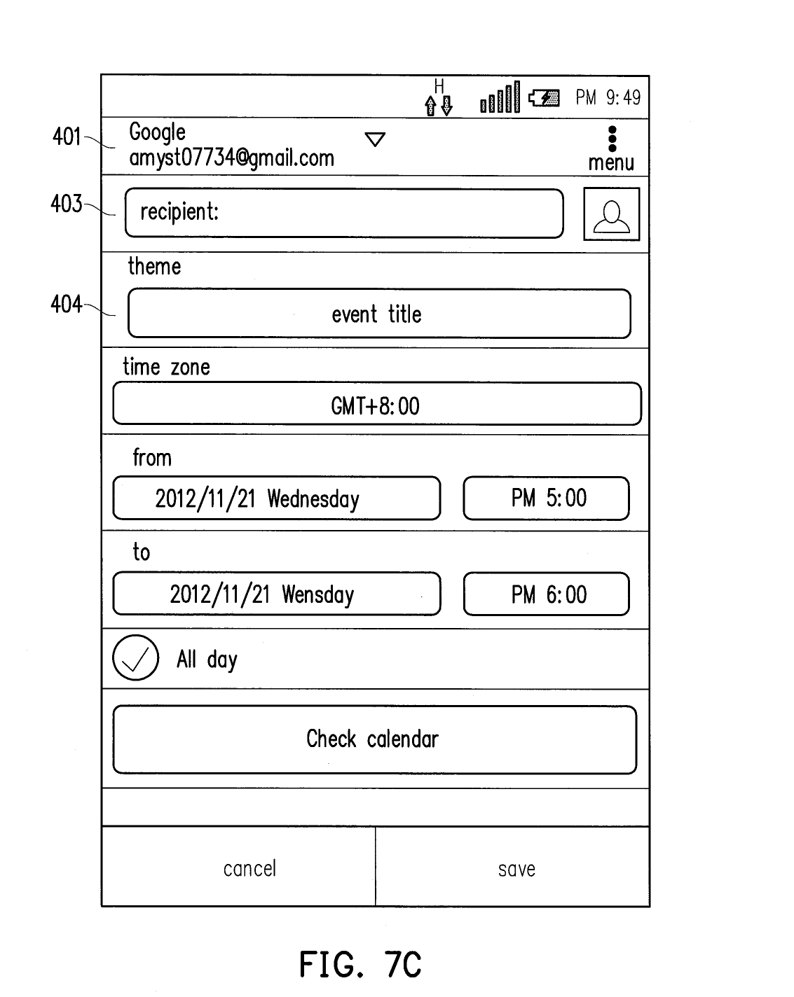

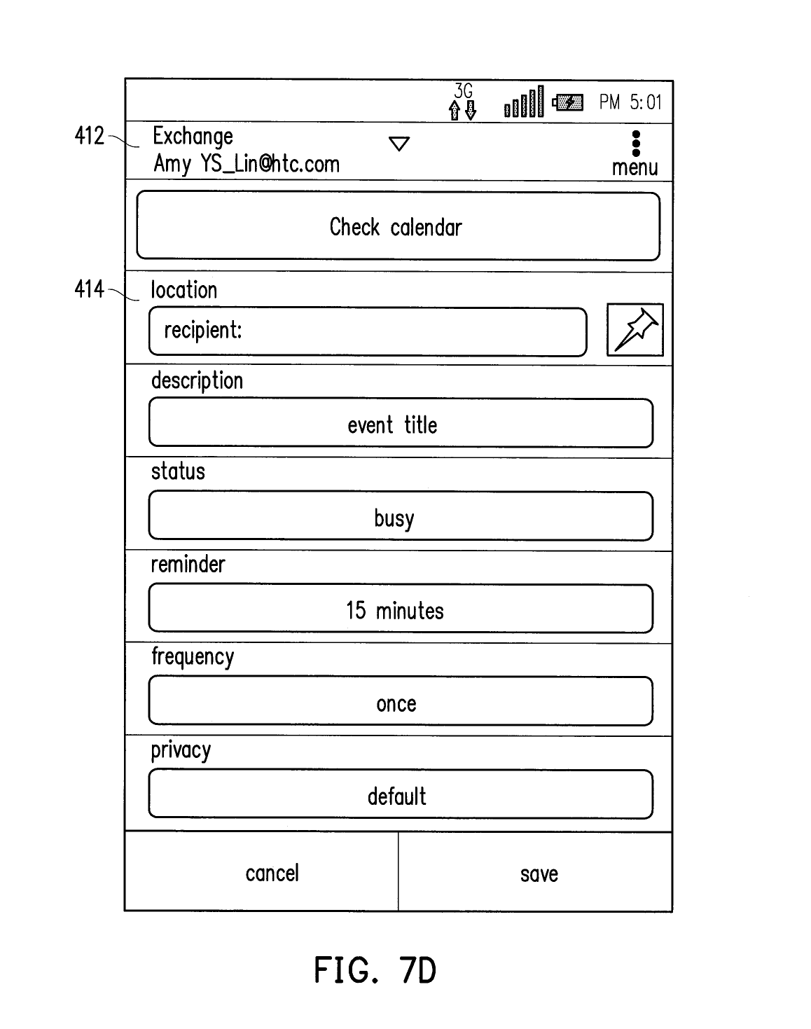

FIG. 7A-7D illustrate a user interaction with the calendar application or widget based on the online calendar function. FIG. 7A illustrates the agenda view of a list of events integrating an online calendar function. The detail description of each downloaded online calendar data is generated when online calendar is synchronized with a mobile phone. If a user taps on the an item on the Agenda view or its corresponding reminder when the online calendar data is displayed, the detail descriptions may be generated and displayed as shown in FIG. 7A. The item 701 shows an event downloaded from an online calendar. The event for this example is the Chinese New Year event schedule for January of 2012. If a user touches the item of the event 701, the user is taken to the Holiday details view illustrates in FIG. 7B. The Holiday details view of FIG. 7B is similar to the event details view of FIG. 3, but one difference is the Edit Event button 711.

When the user taps on the “Edit Event” button, a dialog interface will be displayed for the user to create an event and invite friends to join the event. FIG. 7C illustrates the dialog interface for editing an event and for inviting friends from Google. When the user logs into Google through one's email 401, the user can identify one or more recipient 403 or invitee or add a title 404 through a dialogue interface. As shown in FIG. 7C, the user may edit the event message and add at least one event invitee through the dialog interface. When a user taps on the “save” button, the event information will be sent to the online calendar service to share the event with friends through the user's online calendar, and the invitation will be sent to all invitees. The same concept applies for an email service such as Exchange. Referring to FIG. 7D, when a user logs into an email program such as Exchange 412 one one's own electronic device, the user may identify at least one recipient 414 and edit event information to send event invitations to all recipients identified in the dialogue interface.

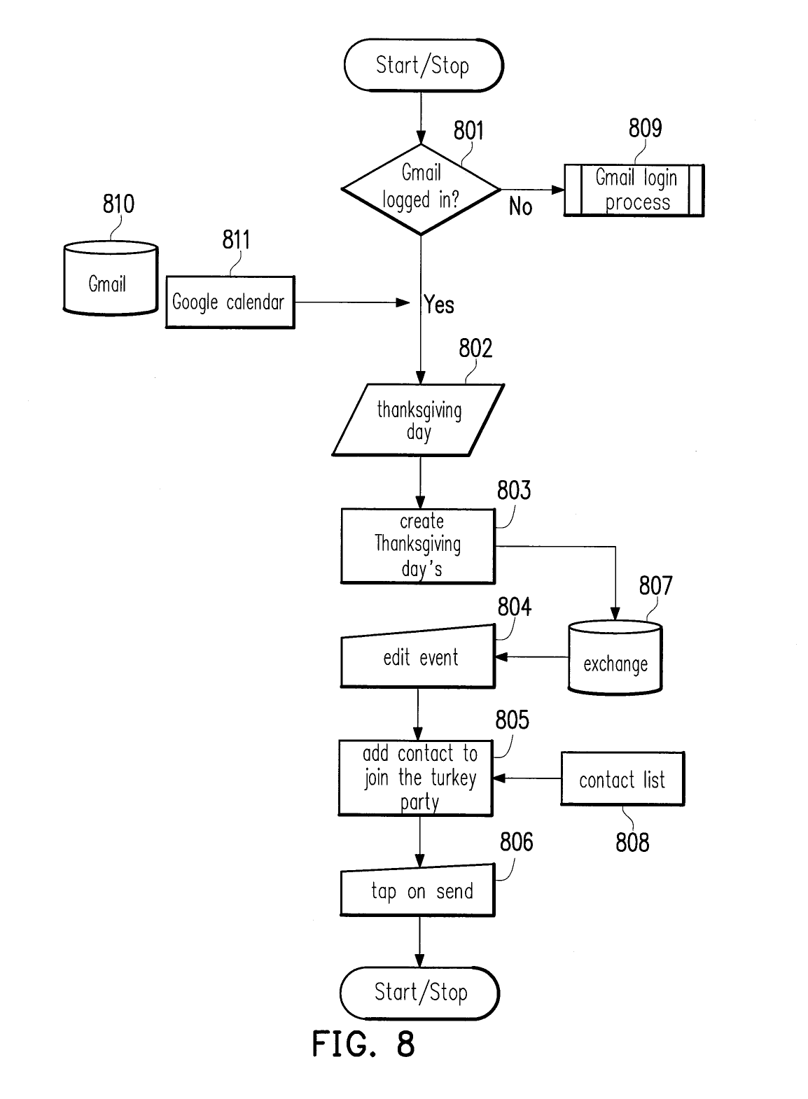

FIG. 8 is a flow chart illustrating an example of integrating Google calendar into the calendar application/widget and create an invitation of an event corresponding to the calendar data from Google calendar. In step 801, the mobile phone determines whether a user is logged into the Gmail service. If no, then in step 809, the user may be required to log into Gmail. If yes, the Google calendar 811 from the Gmail server 810 is synchronized with an email database on the mobile phone such as Exchange. In step 802, a user extracts a Thanksgiving day event from the Google calendar 811. In step 803, the Thanksgiving day event is generated in the calendar application/widget and may be available to be selected through the agenda view or through other views and subsequently in step 807 the event in saved into the calendar database of the mobile device. In step 804, a user may edit an event, or particularly the Thanksgiving event stored in Exchange 807, by tapping on the edit button in the holiday details view of FIG. 7B to bring up a dialogue interface. From the dialogue interface in step 805, a user may find friends from a contact list 808 of an email database to execute step 806 which is to send invitations to friends to join the Thanksgiving party by tapping on the send button of the dialogue interface.

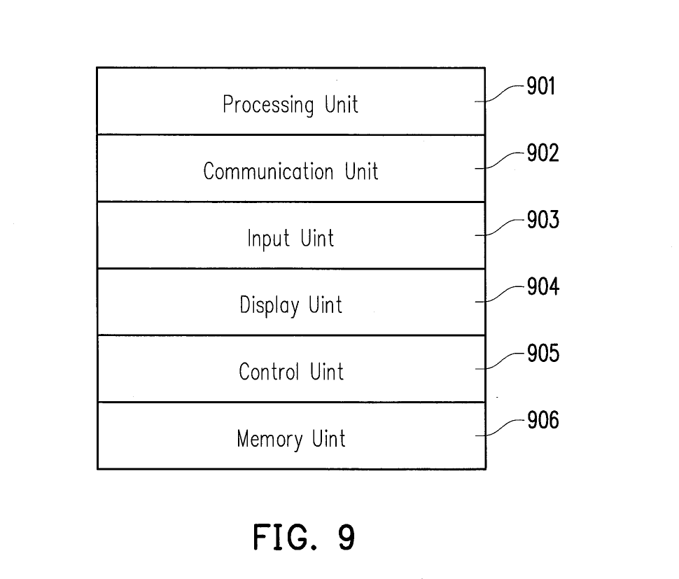

FIG. 9 illustrates a mobile device electronic device for executing a calendar function according to an exemplary embodiment of the present disclosure. The mobile electronic device may contain electrical circuits including but not limiting to a processing unit 901, a communication unit 902, an input unit 903, a display unit 904, a control unit 905, and a memory unit 906. The processing unit 901 and the control unit 905 are connected to the communication unit 902, the input unit 903, the display unit 904, the control unit 905, and the memory unit 906.

The display unit 904 may be a touch screen equipped with sensors for receiving touch signals. The input unit 903 may receive and process various input signals from a user. For instance, the input unit may receive a touch input signal from the touch screen and determine a precise location of the touch signal. The control unit 905 coordinates various control signals within the electronic device. The communication unit 902 may include transceivers, filters, mixers, an analog to digital converter, a digital to analog converter, low noise amplifiers, gain stages, power amplifiers, GPS devices, and signal processing units. The communication unit 902 may synchronize through interne or communication protocols with the cloud storage from social networks, messengers, email servers, or calendar servers.

The non-transitory memory unit 906 contains program instructions including instructions for executing the calendar functions and contain user data including data stored by the calendar application or widget. The processing unit 901 may execute functions related to the calendar application or widget through the control unit 905, the communication unit 902, the input unit, the display unit 904, the control unit 905, and the memory unit 906.

In view of the aforementioned descriptions, the present disclosure provides a calendar application or widget for use on a handheld electronic mobile device which is able to synchronize with external data storages from the cloud storage to obtain data including birthdays, social events, holidays, anniversaries, and user defined events. Upon synchronizing the data, a user is able to send birthday greetings to be posted on a webpage of a social network without launching the social network website. The user is also able to synchronize events with a calendar server including social or holiday events, send invitations to selected contact list, edit the event, and synchronize the edited event with the calendar server.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of using an electronic calendar in a handheld mobile device, the method comprising:
synchronizing the electronic calendar with an external data storage to generate a first synchronized data;
generating automatically a first event according to the first synchronized data;
entering a first response based on the first event;
transmitting the first response; and
synchronizing the first response with the external data storage.

2. The method of claim 1 further comprising:
displaying the first response on a social networking website without launching the social networking website.

3. The method of claim 1 further comprising:
creating an invitational list for the first event; and
synchronizing the invitational list with the external data storage.

4. The method of claim 3 further comprising:
transmitting the first response to members on the invitation list.

5. The method of claim 4 wherein transmitting the first response to members on the invitation list comprising:
transmitting a text message, an email, a video, or a file attachment to each member of the invitation list.

6. The method of claim 3 further comprising:
synchronizing automatically the first event on a website with invited guests from the invitation list without launching the website.

7. The method of claim 1 further comprising:
setting a reminder message to be triggered before a predetermined time period of the first event; and
triggering the reminder message before the predetermined time period of the first event.

8. The method of claim 1 further comprising:
selecting and dropping the electronic calendar on a home screen of the handheld mobile device; and
displaying the electronic calendar as a widget on the home screen.

9. The method of claim 2, wherein the first response is a birthday greeting.

10. The method of claim 1 wherein the first synchronized data with the external data storage comprises data from a web based social networking website, from a messenger service, from an email server, or from a calendar server.

11. A handheld mobile electronic device, comprising:
a communication unit for synchronizing the electronic calendar with an external data storage to generate a first synchronized data;
a storage unit for storing the first synchronized data;
an input unit: for inputting a first response based on the first synchronized data;
a processor connected to the communication unit, to the storage unit, and to the input unit and configured for automatically generating a first event based on the first synchronized data; for transmitting the first response through the communication unit, and for synchronizing the first response with the external data storage through the communication unit.

12. The handheld mobile electronic device of claim 11, wherein the communication unit is further configured for transmitting the first response to be displayed on a social networking website without launching the social networking website.

13. The handheld mobile electronic device of claim 11, wherein the processor is further configured for synchronizing through the communication unit an invitational list created for the first event with the external data storage.

14. The handheld mobile electronic device of claim 13, wherein the communication unit is further configured for transmitting the first response to members on the invitation list.

15. The handheld mobile electronic device of claim 14, wherein the first response comprises a phone call, a text message, an email, a video, or a file attachment.

16. The handheld mobile electronic device of claim 11, wherein the communication unit is further configured for transmitting the first event and the invitational list to be generated as a social event with a invited guest list on a website without launching the website.

17. The handheld mobile electronic device of claim 11, wherein the processor is further configured for setting a reminder message to be triggered before a predetermined time period of the first event, and triggering the reminder message before the predetermined time period of the first event.

18. The handheld mobile electronic device of claim 11 further comprising:
a display unit for displaying the electronic calendar as a widget on the home screen when the electronic calendar is selected and dropped on the home screen of the handheld electronic mobile device.

19. The handheld mobile electronic device of claim 12, wherein the first response is a birthday greeting.

20. The handheld mobile electronic device of claim 11 wherein the communication device is further configured for synchronizing with the external data storage from a web based social networking website, from a messenger service, from an email server, or from a calendar server.
